(19) United States
(12) Patent Application Publication
(10) Pub. No.: US 2007/0087794 A1
(43) Pub. Date: Apr. 19, 2007

(54) Multi Function Mobile Unit for objects and devices

(76) Inventor: Christopher Nicholas Choi, New Berlin, WI (US)

Correspondence Address: CHRISTOPHER CHOI, 14800 W. DAKOTA ST., NEW BERLIN, WI, 53151, US

(21) Appl. No.: 11/163,459

(22) Filed: Oct. 19, 2005

(51) Int. Cl. H04M 1/00

(52) U.S. Cl. 455/575.6

(57) ABSTRACT

The present invention allows multiple devices to be merged into one completed mobile unit. Using “like Velcro” material, user can easily attach and detach a device from the mobile unit. This flexibility allows user to use the selected device individually or as part of the completed mobile unit. For example a cellular telephone can be used as itself or be used in conjunction with the mobile unit while a PDA is attached to the opposing side of the cellular phone. As another example, a PDA can be used in conjunction with the mobile unit with a cellular phone attached to the other side of the mobile unit. The mobile unit helps to organize several devices and allows multiple devices to act as one unit. The completed system can be divided into 3 sections. A clip section consists carbine styled clip or hook like piece that attaches the main body to an anchoring junction. The main body section consists of feature for clip like part and features for attaching the modified devices. The attaching section consists of modified device with feature to attach onto the main body section.

### CROSS-REFERENCES TO RELATED APPLICATIONS

Not applicable.

### STATEMENT REGARDING FEDERALLY SPONSORED RESEARCH OR DEVELOPMENT

Not applicable.

### REFERENCES TO MICROFICHE APPENDIX

Not applicable.

### BACKGROUND

1. Field of Invention

This invention relates to small portable devices that are carried by a person. The invention allows consolidation of several devices into one. The mobile unit will have two sides with attachable surfaces for holding objects. In particular, at least one clip like device is attached to the main body for mounting the main body to an anchor junction.

2. Discussion of Prior art

Many other inventions that attempt to ease the portability and carrying of portable devices either:

Are designed for one unit

Are more like a portable carrying bag in which a device has to be removed from the bag in order to operate the device.

Are more of a protective layer for a device than a consolidation unit.

Are designed as a holder for a single device rather than transforming multiple devices into one unit that has functions of all the devices attached without being removed.

One style of the personal carrying unit is described in U.S. Pat. No. 6,945,503 B2, issued to Cohen on Sep. 20, 2005. Cohen's invention doesn't allow for quick detachment of the whole unit. It is designed so the magnetic object holder remains fitted and the attachable item is attached or detached in order to operate the attachable device.

Another style of personal carrying unit is described in U.S. Pat. No. 6,729,518 B2, issued to Badillo on May 4, 2004. Badilo's invention is more of a device holster that uses pockets and compartments of the unit to hold devices. This particular design functions due to its bendable “leg”.

Other known device holders are capable of transporting and/or protecting only one device. Included have been U.S. Pat. No. 6,880,737 B2, issued to Bauer, on Apr. 19, 2005; U.S. Pat. No. 6,646,864 B2, issued to Richardson on Nov. 11, 2003; U.S. Pat. No. 6,932,309 B1, issued to Corey on Aug. 23, 2005; U.S. Pat. No. 6,799,354 B1, issued to Goradesky on Oct. 5, 2004; U.S. Pat. No. 6,427,293 B1, issued to Bowes, Jr. on Aug. 6, 2002; U.S. Pat. No. 6,550,108 B2, issued to Pratl on Apr. 22, 2003; U.S. Pat. No. 6,742,685 B2, issued to Williams on Jun. 1, 2004; U.S. Pat. No. 6,799,354 B1, issued to Goradesky on Oct. 5, 2004. These inventions are designed to hold one device.

### SUMMARY (OBJECTS AND ADVANTAGES)

It is an object of the present invention to minimize the disadvantage of carrying multiple objects and also to improve the method in which a user can use multiple devices by merging several devices into one unit. Other objects and advantages are:
(1) Allows for the use of a wide range of attachment parts to fasten the invention to various attachment junctions.
(2) Allows for one or more portable devices to be attached to the present invention.
(3) Devices that are attached to the mobile unit can still be operated in that attached state by removing the whole completed mobile unit from the attachment junction.
(4) If a cellular telephone is part of the completed mobile unit, you can operate the phone in the completed mobile unit state.
(5) A portable unit can be attached and removed with ease.
(6) If a personal digital assistant (PDA) is part of the completed mobile unit, you can operate the PDA in the completed mobile unit state.
(7) If a portable music-playing device is part of the completed mobile unit, you can operate the music-playing device in the completed mobile unit state.
(8) The mobile unit can be hooked, attached, or placed to almost anything using the proper attachment feature.
(9) Allows user to remove any device from the mobile unit without any special tool.
(10) Unlimited possibility to what can be attached to the mobile unit. These devices may include but are not limited to cellular telephones, personal digital assistants (PDA's), radios, global positioning systems (GPS), cameras, flashlights and other similar devices.
(11) Different types of material can be used to allow for low strength bonding, mid strength bonding, and heavy strength bonding. Depending on type of application, the bonding material on the main body and attachable part can change for various bond strength.
(12) Almost any object can be modified to attach on to the mobile unit.
(13) Current invention can be used as a key chain.
(14) Current invention can be used with all key chain related accessories.
(15) All the components that make up the mobile unit can come in various colors, shapes, materials, and sizes to function as listed above.
(16) Main body of the current invention can be used with bigger plate to attach bigger/heavier objects.
(17) Main body of the current invention can be used with smaller plate to attach smaller/lighter objects.
(18) Main body of the current invention can be rigid or flexible, depending on the type of material inserted between the two attachable surfaces. In one variation the main body can consist of only the attachable surfaces and nothing inserted between them.

### DESCRIPTION OF DRAWINGS

FIG. 1 is an isometric view of the embodiment of the invention with a Cellular telephone and a PDA. This state with objects attached to the mobile unit is the completed mobile unit.

FIG. 2 is a view of the embodiment of the invention with the two devices, detached. A modified device can attach to the mobile unit.

FIG. 3 shows front and side view of the mobile unit.

FIG. 4 shows the front and side view of the main body of the mobile unit.

FIG. 5 Shows an example of the completed mobile unit being used as a cellular phone.

FIG. 6 Shows an example of the completed mobile unit being used as a PDA.

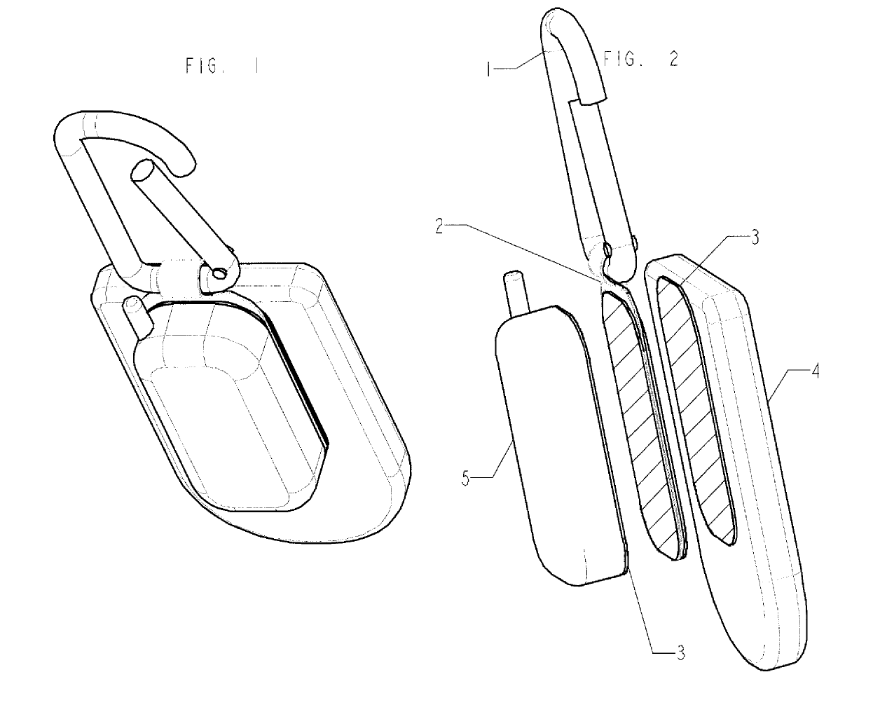

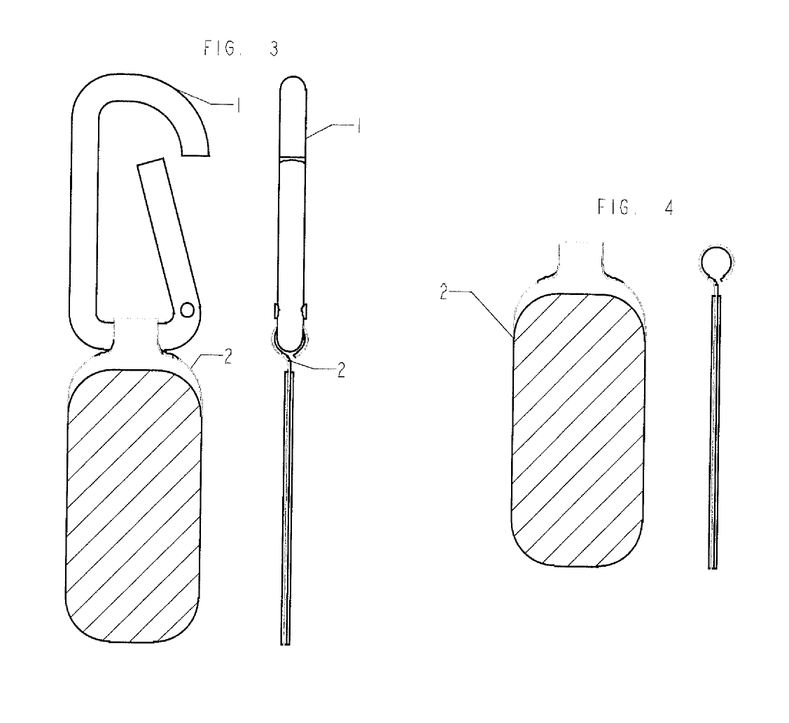

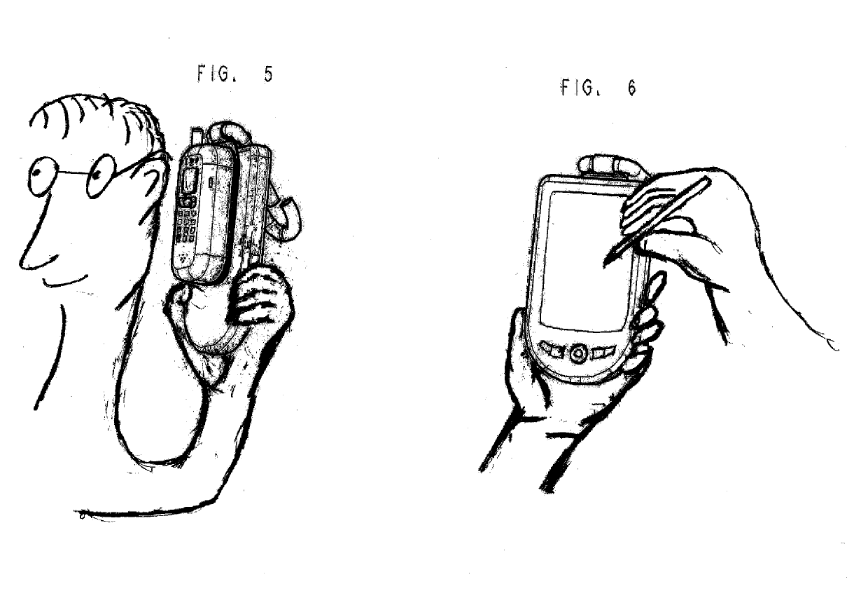

### LIST OF REFERENCE NUMERALS

1 Clip

2 Main body

3 Attachable part

4 Object “A”

5 Object “B”

### DESCRIPTION OF INVENTION

Preferred embodiment of the unit is set up for carrying portable devices. The completed mobile unit can be divided into 3 sections. The clip section consists of clip 1. The main body section consists of main body 2. The attaching section consists of attachable part 3, object “A” 4, and object “B” 5. The present invention, or the mobile unit, consists of clip 1, main body 2, and attachable part 3.

Clip 1 that is used to attach the main body 2 on one end and is attached to a junction on the other end. Main body 2 provides attaching features for the attachable part 3 so the attaching section can be attached to the main body 2. The mobile unit is formed when the clip section is connected to the main body section. The completed mobile unit then can be attached to belt, loop, bags, purses, and other anchoring junctions. If a cellular phone is part of the completed mobile unit, the user does not need to detach the cellular telephone from the completed mobile unit to use it. The user can simply detach the completed mobile unit from the anchoring junction to fully operate the cellular telephone. PDA, Portable music devices, and many other devices can be used while in a completed mobile unit state.

### OPERATION OF INVENTION

A user will attach attachable part 3 to object “A” 4 and/or object “B” 5. This modified device or object will then be mated to the mobile unit. A user will use clip 1 of the invention to attach the mobile unit to an anchoring junction. To operate a device on the completed mobile unit, a user can detach the object from the mobile unit or detach the whole completed mobile unit as if the whole completed mobile unit is acting as the selected device or an object. Once a user is finished operating the device or object, a user can re-attach the object on to the mobile unit or re-attach the completed mobile unit to an anchoring junction, depending on how a user decides to operate the device or object.

### DESCRIPTION AND OPERATION OF ALTERNATIVE EMBODIMENTS

There are various possibilities to change the configuration of the invention to allow the invention to look and perform differently:

Clip 1, main body 2, attachable part 3, object “A” 4, object “B” 5.

Clip 1 can be substituted with another kind of hooking part, or assembly, that allows union of at least two junctions.

Combinations of multiple clip 1 pieces and main body 2 pieces can be joined to allow for more variations. For example, a variation of the mobile unit can consist of one clip 1 with two or more main body 2 pieces. Another example, a variation of the mobile unit can consist of two or more main body 2 pieces attached to each other. Another example, two or more mobile units can be attached to each other via clip 1, main body 2, or additional clip like part.

Main body 2 can be bigger or smaller with attachable feature(s) of varying bonding strength.

All parts for the mobile unit can be any shape, size, color, and materials to provide the function as described in this patent.

Main body 2 can consist of part or parts to be rigid or pliable.

Main body 2 can consist of attachable features like “Velcro”, magnet, or other material that allows some level of bonding to another material.

Main body 2 can be made larger or smaller to allow for appropriate surface area for various objects.

Attachable part 3 can consist of attachable features like “Velcro”, magnet, or other material that allows some level of bonding to another material. Once the attachable part 3 is bonded to a device or object, that device becomes the modified device.

Mobile unit can be used as a key chain and therefore can be used with anything that can be used with a key chain.

Mobile unit can be used to carry electronic devices, tools, school supplies, camping equipment, and other objects that can be carried by a user.

### CONCLUSIONS, RAMIFICATIONS, AND SCOPE OF INVENTION

Thus the reader will see the mobile unit is not only an excellent way to organize multiple devices, but is also a very convenient way to use the selected device. User does not need to search for a particular device in a pocket or in a bag, because the mobile unit will be attached to a known junction with the devices. Multiple devices merged as one complete mobile unit provides functionalities of the attached devices and can easily be detached and transported.

What is claimed is:

1. Having thus described my invention, I claim:
An apparatus for holding objects and devices, comprising:
(a) main body section with feature to allow for hook or loop to go through;
(b) main body section with feature(s) to allow attachment for device or object that has been modified for attachment functionality.

2. An apparatus for holding objects and devices as described in claim 1 and further comprising:
(a) clip section, which joins at least one main body section to an anchoring junction.

3. An apparatus for holding objects and devices as described in claim 1 and further comprising:
(a) attachable part at that will be used to modify a device or object so that it can be attached to the main body section.
